(19) United States
(12) Patent Application Publication
(10) Pub. No.: US 2016/0375489 A1
(43) Pub. Date: Dec. 29, 2016

(54) Build Reinforcement for Sintering Laser Manufacturing

(71) Applicant: CATERPILLAR INC., Peoria, IL (US)

(72) Inventor: Thierry Marchione, Heber City, UT (US)

(73) Assignee: CATERPILLAR INC., Peoria, IL (US)

(21) Appl. No.: 14/751,566

(22) Filed: Jun. 26, 2015

(51) Int. Cl. B22F 3/105; B22F 3/00

(52) U.S. Cl. CPC B22F 3/1055; B22F 3/003; B22F 2003/1057; B33Y 10/00

(57) ABSTRACT

A system for manufacturing one or more objects is disclosed. The system includes a laser configured to selectively heat a powdered material to form the one or more objects in a series of layer-wise iterations. The system further includes an object bed, on which the one or more objects rest during manufacturing. The object bed is lowered by a layer height in conjunction with each of the series of layer-wise iterations. The system further includes a roller configured to spread a powder layer of the powdered material on to the object bed prior to each of the series of layer-wise iterations. The system further includes a roller support structure formed from the powdered material by the laser during the series of layer-wise iterations.

### TECHNICAL FIELD

The present disclosure generally relates to additive manufacturing systems and, more particularly, relates to systems and methods for additive manufacturing that employ a roller and iteratively constructed supports for said roller.

### BACKGROUND

Additive manufacturing, also known as three-dimensional (3-D) printing, can be used for manufacturing an extremely wide array of 3-D objects. By utilizing additive manufacturing, the object designer has few restrictions on what he/she can create. Such unique, unrestricted manufacturing can be performed in both a time-effective and cost-effective manner when utilizing additive manufacturing.

In particular, additive manufacturing is valuable in the production of metal machine components because it can reduce the need for casting. Casting may be cost prohibitive, especially when used to create small-scale production components, such as parts for old machines, parts for small-scale produced machines, or custom components. By utilizing additive manufacturing of metal components, metal components can be manufactured in a cost-effective manner and time-effective manner.

Often, laser sintering techniques are employed to produce metal objects via additive manufacturing. Additive manufacturing employing laser sintering, or “selective laser sintering,” involves using a laser to selectively heat a powdered material to bond the powder into a solid layer of an object. Selective laser sintering produces objects in a layer-wise manner, wherein each layer of the object is fused to the previous layer.

In addition to the powdered material and the laser, selective laser sintering methods may, generally, involve an object bed, a roller, and a scraper. The object bed is a platform on which the object is formed via selective laser sintering. Prior to each sintering iteration performed by the laser, the roller spreads a layer of the powdered material on to the object bed. Once the layer is laid, the laser selectively heats or sinters portions of the layer of the powdered material to form a first layer of the object. Then, the object bed is lowered, the roller spreads a second layer over the object bed, and the laser selectively sinters a second layer on top of the first layer. This process is repeated for any number of iterations that are needed to produce the object.

However, build failure in objects manufactured by selective laser sintering is possible due to a number of factors. One prevalent factor is over-compression of the sintered layers by the roller. When the roller rolls over the previously sintered layer(s), the roller may excessively compact the powder proximate to the sintered layer(s). Further, forces on the sintered layer(s) caused by the roller may produce deflection on the sintered layer(s), which can lead to build failure and/or shape distortion of the final product.

To aid in structural stability of the object, powders have been developed that include additives to stiffen the powder and, potentially, prevent build failure, as can be seen in U.S. Pat. No. 8,719,144 (“Powder for Layerwise Manufacturing of Objects”). However, additives in the powder used may not be sufficient for lessening or counteracting compaction forces caused by the roller.

Therefore, systems, methods, and apparatus for additive manufacturing, wherein build reinforcement is iteratively constructed in the form of roller supports, are desired.

### SUMMARY

In accordance with one aspect of the disclosure, a system for manufacturing one or more objects is disclosed. The system may include a laser for selectively heating the a powdered material to form the one or more objects in a series of layer-wise iterations. The system may further include an object bed, on which the one or more objects rest during manufacturing; the bed may be lowered by a layer height in conjunction with each of the series of layer-wise iterations. The system may further include a roller configured to spread a powder layer of the powdered material on to the object bed prior to each of the series of layer-wise iterations. The system may further include a roller support structure formed from the powdered material by the laser during the series of layer-wise iterations.

In accordance with another aspect of the disclosure, a method for manufacturing one or more objects is disclosed. The method may include spreading, by a roller, a first powder layer of a powdered material on to an object bed. The method may further include heating, by a laser, first selective object portions of the first powder layer to form a first object layer of the one or more objects. The method may further include heating, by the laser, first selective roller support portions of the powder layer to form a first support layer of a roller support structure.

In accordance with yet another aspect of the disclosure, a three-dimensional (3-D) printer is disclosed. The 3-D printer may include an object bed on which one or more objects are printed, a powder bed for providing a powdered material to the object bed, a roller for spreading the powdered material on the object bed as a powder layer, and a laser for selectively heating the powdered material. The 3-D printer may further include a controller communicatively associated with, at least, the part bed, the roller, the object bed, and the laser. The controller may be configured to execute instructions for spreading a powder layer of the powdered material on to the part bed using the roller prior to each of a series of layer-wise iterations of heating by the laser, heating the powder, using the laser, at selective object portions of the powder layer to form the one or more objects during the series of layer-wise iterations, and heating the powder, using the laser, at selective support portions of the powder layer to form a roller support structure during the series of layer-wise iterations.

Other features and advantages of the disclosed systems and principles will become apparent from reading the following detailed disclosure in conjunction with the included drawing figures.

### BRIEF DESCRIPTION OF THE DRAWINGS

FIG. 1 is a schematic representation of a system for manufacturing objects, the system including a 3-D printer and associated 3-D printer components, in accordance with an embodiment of the present disclosure.

FIG. 2 is a top view of an example layer of a powdered material atop an example object bed of the system of FIG. 1, on which portions of the example layer have been selectively heated by a laser of the system of FIG. 1, to form an object and roller support structures, in accordance with an embodiment of the present disclosure.

FIG. 3 is another top view of an example layer of the powdered material atop the example object bed of the system of FIG. 1, on which portions of the example layer have been selectively heated by the laser of the system of FIG. 1, to form a plurality of objects and substantially parallel roller support structures, in accordance with an embodiment of the present disclosure.

FIG. 4 is another top view of an example layer of the powdered material atop the example object bed of the system of FIG. 1, on which portions of the example layer have been selectively heated by a laser of the system of FIG. 1, to form a plurality of objects and a roller support structure having substantially parallel roller supports and a crossing member therebetween, in accordance with an embodiment of the present disclosure.

FIG. 5 is yet another overhead view of an example layer of the powdered material atop the example object bed of the system of FIG. 1, on which portions of the example layer have been selectively heated by a laser of the system of FIG. 1, to form a plurality of objects and crossing roller support structures, in accordance with an embodiment of the present disclosure.

FIG. 6 is yet another overhead view of an example layer of the powdered material atop the example object bed of the system of FIG. 1, on which portions of the example layer have been selectively heated by a laser of the system of FIG. 1, to form a plurality of objects and an enclosure roller support structure, in accordance with an embodiment of the present disclosure.

FIG. 7 is a schematic depiction of a controller which may be used in conjunction with the system of FIG. 1, in accordance with the present disclosure.

FIG. 8 is a block diagram illustrating a flow chart for a method for manufacturing one or more objects, in accordance with an embodiment of the present disclosure.

While the following detailed description will be given with respect to certain illustrative embodiments, it should be understood that the drawings are not necessarily to scale and the disclosed embodiments are sometimes illustrated diagrammatically and in partial views. In addition, in certain instances, details which are not necessary for an understanding of the disclosed subject matter or which render other details too difficult to perceive may have been omitted. It should therefore be understood that this disclosure is not limited to the particular embodiments disclosed and illustrated herein, but rather to a fair reading of the entire disclosure and claims, as well as any equivalents thereto.

### DETAILED DESCRIPTION

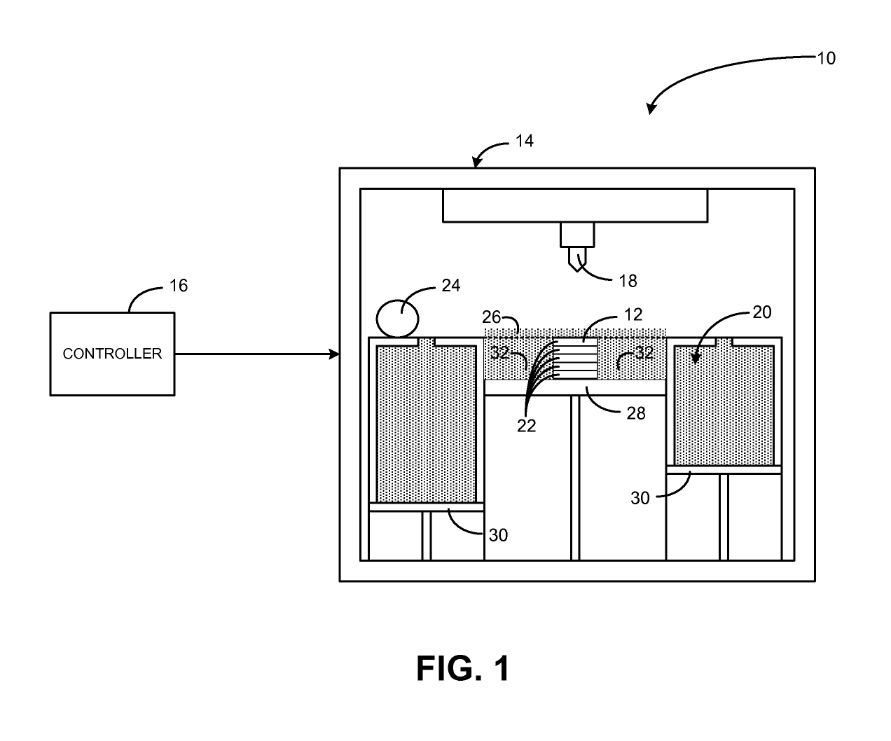

Turning now to the drawings and with specific reference to FIG. 1, a system 10 for manufacturing an object 12 is disclosed. The system 10 may manufacture the object 12 using additive manufacturing, which may also be referred to as three-dimensional (3-D) printing. To 3-D print the object 12, the system 10 includes the 3-D printer 14 and its associated elements, which are explained in more detail below. The 3-D printer 14 may receive instructions for 3-D printing the object 12 from the controller 16. Any known method of 3-D printing can be used in conjunction with the system 10, such as, but not limited to, selective laser sintering methods.

The 3-D printer 14 employs a laser 18 to selectively heat portions of a powdered material 20 to form the object 12 in a series of layers 22 during a series of layer-wise iterations of the laser 18. “Layer-wise,” generally, refers to the manufacturing of a structure by subdividing the construction into a series of layers and compiling the structure as a series of layers. Each of such a series of layers is performed iteratively by the 3-D printer 14, and, therefore the object 12 is formed in a series of layer-wise iterations. For performing the selective heating, the laser 18 may be any selective heating laser, such as a selective sintering laser for performing selective laser sintering. The powdered material 20 may be any type of material that can be selectively heated to form the object 12, which may include, for example, nylon additive material powders and metallic material powders. The powdered material 20 may further include any additives known in the art to aid in bonding, stiffening, or otherwise provide structural support in the manufacturing process of the object 12.

The series of layer-wise iterations of the laser 18 may be controlled in accordance with instructions stored on memory associated with the controller 16. Prior to each layer-wise iteration of the laser 18, a roller 24 lays a powder layer 26 of the powdered material 20 over an object bed 28, on which the object 12 will rest during 3-D printing. The powdered material 20 may be provided to the roller 24 for spreading by one or more powder beds 30. Additionally, the roller 24 may compact the powder layer 26 after laying the powder layer 26.

After each iteration of the laser 18, the object bed 28 may be lowered by a layer height. Then, another powder layer 26 may be laid over the object bed 28 so that the next iteration of the laser 18 may occur. After each iteration, excess powdered material 32 may remain on the object bed 28 and the next layer may be spread over the excess powdered material 32 by the roller 24. Such excess powdered material 32 may remain on object bed 28 and can act as a support base for the currently laid powder layer 26.

Each layer 22 of the object 12 is selectively heated such that it fuses with the previously heated layer 22. The 3-D printer 14 may continue this process for however many layers 22 are required to manufacture the object 12. Once manufacturing is completed, the object 12 may be removed from the 3-D printer 14.

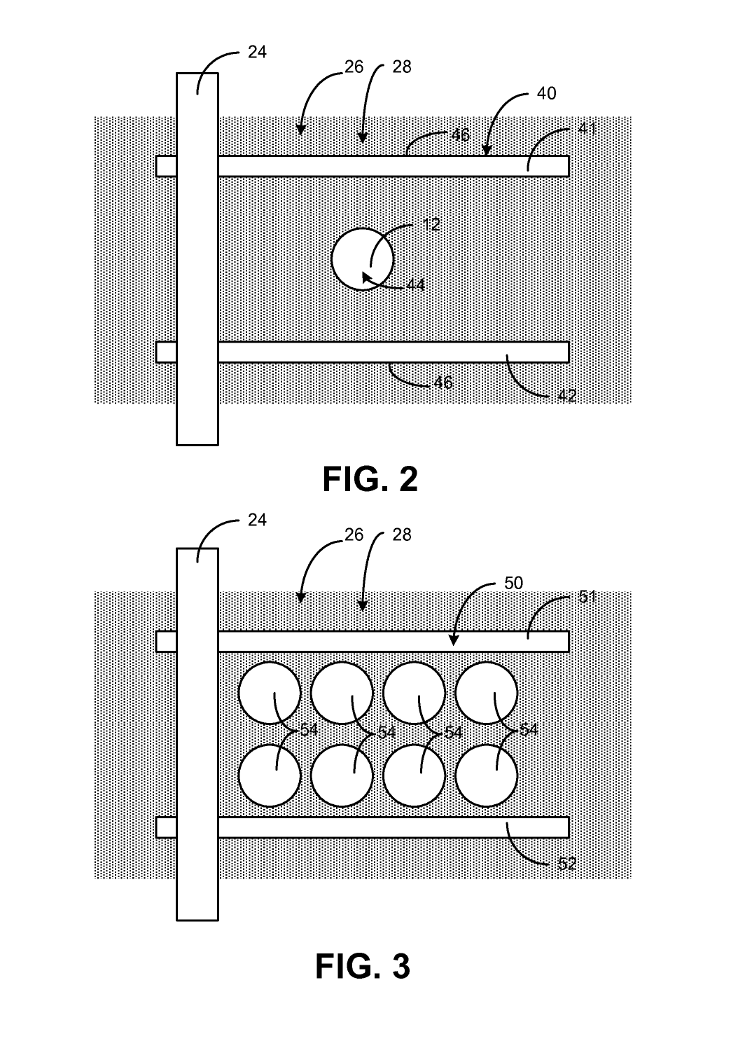

As shown in the overhead view of the powder layer 26 atop the object bed 28 in FIG. 2, the system 10 may further include a roller support structure 40. The roller support structure 40 may include, for example, any number of support members, such as the first member 41 and the second member 42. The roller support structure 40 may be 3-D printed by the 3-D printer 14 during the manufacturing of the object 12, thereby being iteratively manufactured in a layer-wise manner in conjunction with the manufacturing of the object 12. For example, the roller support structure 40 may have the same or a similar number of layers as the object 12. As the object 12 is formed when the laser 18 heats an object portion 44 of the powder layer 26, the roller support structure 40 may be formed when the laser 18 heats roller support portion(s) 46 of the powder layer 26. The roller support structure 40 may be formed while not having any contact with the object 12, but still constructed in a layer-wise manner during the same manufacturing process used to manufacture the object 12.

The roller support structure 40 may engage with and support the roller 24 when it spreads the powdered material 20 across the surface of the object bed 28. Accordingly, the roller 24 may be in contact with the roller support structure 40 and roll or otherwise move on top of the roller support structure 40 as the roller 24 lays layers of the powdered material 20, thereby decreasing forces applied to the object 12 by the roller 24. Using the roller support structure 40, deflection on the object 12 may be decreased, thereby potentially reducing or eliminating shape distortion of the object 12. Including a roller support structure 40 iteratively built in conjunction with manufacturing of the object 12 may lower the compression caused by the roller 24 on the object 12 and thereby reduce overall rates of build failure during 3-D printing.

Of course, by executing different instructions for the 3-D printer 14, a variety of configurations of object(s) 12 and associated roller support structures 40 can be formed, as is shown in the overhead views of the object bed 28 of FIGS. 3-6. Beginning with FIG. 3, a layer of a roller support structure 50 is shown having first and second members 51, 52, wherein a plurality of objects 54 are formed between the first and second members 51, 52. The first and second members 51, 52 may be substantially parallel to one another. The first and second members 51, 52 may support the roller 24 such that over-compression and deflection from the roller 24 on the plurality of objects 54 is reduced or eliminated.

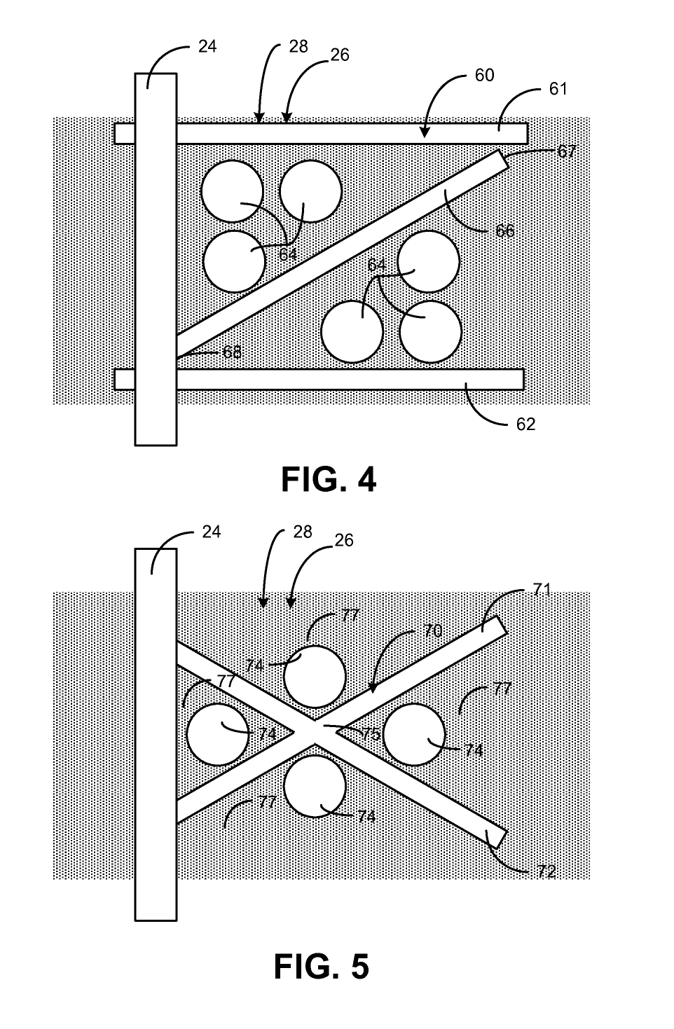

For even more support, another example roller support structure 60 is shown in FIG. 4. Similar to the roller support structure 50 of FIG. 3, the roller support structure 60 may include first and second members 61, 62, which are substantially parallel to one another and between which a plurality of objects 64 are manufactured. Additionally, the roller support structure 60 may include a crossing member 66. For example, the crossing member 66 may cross the substantially parallel first and second members 61, 62, having a first end 67 proximate to the first member 61 and a second end 68 proximate to the second member 62. The crossing member 66 may provide additional support for the roller 24, leading to further reduction in likelihood of build failure.

Further, FIG. 5 shows yet another example roller support structure 70. The roller support structure 70 includes, at least, first and second members 71, 72 which are arranged in a crossing manner, intersecting at an intersection 75. The roller support structure 70 may form and/or define a plurality of chambers 77, within which a plurality of objects 74 are manufactured. The roller support structure 70 may provide support for the roller 24, leading to a reduction in build failure for the plurality of objects 74.

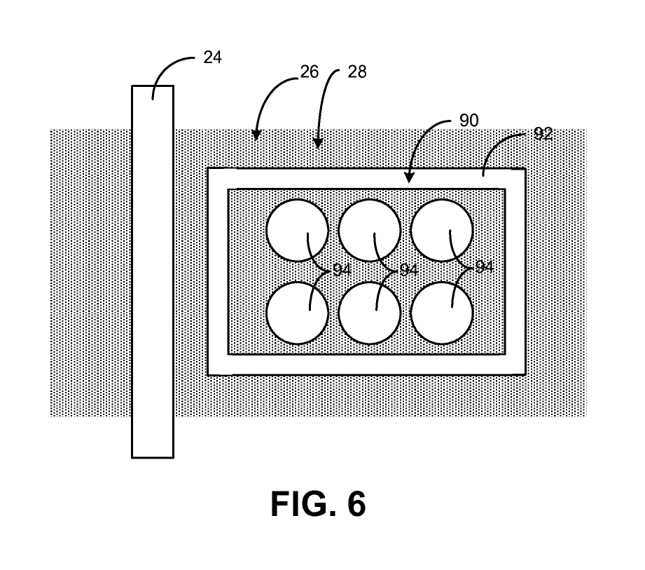

Another example roller support structure 90 is shown in FIG. 6. The support structure 90 of FIG. 6 is arranged as an enclosure 92 disposed outside of a plurality of objects 94. The enclosure 92 may be shaped in any form that encloses the plurality of objects 94, such as a rectangular form as shown in FIG. 6. Such an enclosure 92, as part of the roller support structure 90, provides support for the roller 24 during operation, which may lead to a reduction in build failure of the plurality of objects 94.

As mentioned above, the controller 16 may be used to control the elements of the 3-D printer 14 to manufacture any of the objects 12, 54, 64, 74 and/or any of the roller support structures 40, 50, 60, 70. 3-D printing instructions may transform an object design (e.g., for the object 12) into cross-sections which are used to form successive layers (e.g., the layers 22) by the 3-D printer 14. Instructions executed by the controller 16 may include tool path instructions for the laser 18, which instruct the laser 18 to selectively heat the powder layer 26 as specific regions (e.g., the object portion 44 and/or the support portion(s) 46). Guidance of the laser 18 may be performed by any laser guidance device associated with the 3-D printer 14 such as, but not limited to, an X-Y direction actuator. Additionally, instructions executed by the controller 16 to control the 3-D printer 14 may include instructions for raising the powder bed 30 to provide powdered material 20 to the roller 24, instructions for laying the powder layer 26 over the object bed 28 using the roller 24, and/or instructions for lowering the object bed 28 after each layer-wise iteration of the laser 18.

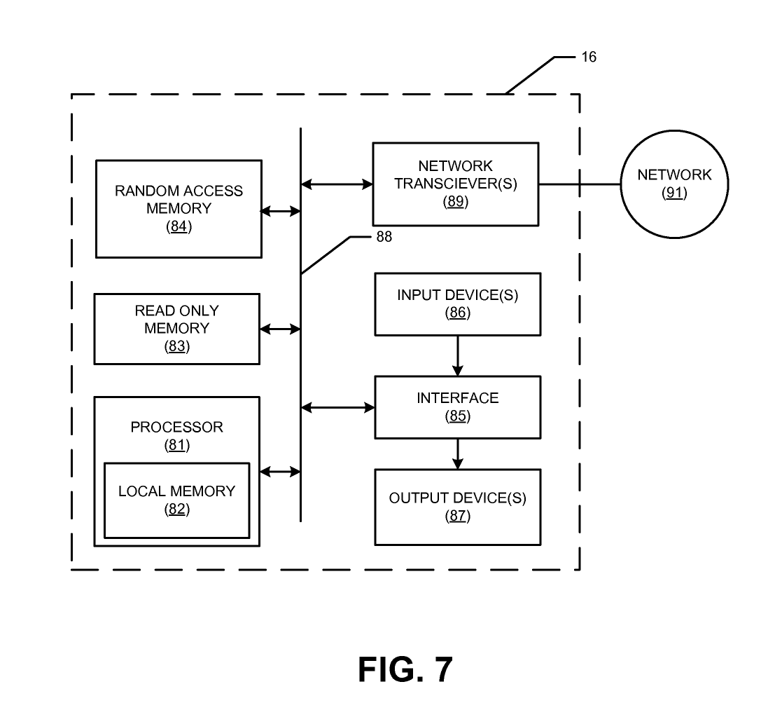

The controller 16 may be a computer associated with or included within the 3-D printer 14. The controller 16 may be hardwired to the 3-D printer 14 or may, additionally or alternatively, transmit instructions to the 3-D printer 14 via a network. FIG. 7 is a block diagram of the controller 16 as a computer capable of executing instructions to direct the 3-D printer 14 to manufacture the object(s) 12. The controller 16 may be, for example, a server, a personal computer, or any other type of computing device. The controller 16 of the instant example includes a processor 81. For example, the processor 81 may be implemented by one or more microprocessors or controllers from any desired family or manufacturer.

The processor 81 may include a local memory 82 and is in communication with a main memory including a read only memory 83 and a random access memory 84 via a bus 88. The random access memory 84 may be implemented by Synchronous Dynamic Random Access Memory (SDRAM), Dynamic Random Access Memory (DRAM), RAMBUS Dynamic Random Access Memory (RDRAM) and/or any other type of random access memory device. The read only memory 83 may be implemented by a hard drive, flash memory and/or any other desired type of memory device.

Further, the controller 16 may also include an interface circuit 85. The interface circuit 85 may be implemented by any type of interface standard, such as, for example, an Ethernet interface, a universal serial bus (USB), and/or a PCI express interface. One or more input devices 86 may be connected to the interface circuit 85. The input device(s) 86 permit a user to enter data and commands into the processor 81 (e.g., directions for 3-D printing instructions). The input device(s) 86 can be implemented by, for example, a keyboard, a mouse, a touchscreen, a track-pad, a trackball, and/or a voice recognition system. One or more output devices 87 may also be connected to the interface circuit 85. The output devices 87 can be implemented by, for example, display devices for associated data (e.g., a liquid crystal display, a cathode ray tube display (CRT), etc.).

The controller 17 may include one or more network transceivers 89 for connecting to a network 91, such as the Internet, a WLAN, a LAN, a personal network, or any other network for connecting the controller 16 to the 3-D printer 14, one or more other controllers, and/or other network capable devices. As such, the controller 16 may be embodied by a plurality of controllers 16 for providing instructions to the 3-D printer 14.

As mentioned above the controller 16 may be used to execute machine readable instructions. For example, the controller 16 may execute machine readable instructions to direct the 3-D printer 14 to print the object(s) 12, 54, 64, 74 and associated roller support structures 40, 50, 60, 70. In such examples, the machine readable instructions comprise a program for execution by a processor such as the processor 81 shown in the example controller 16. The program may be embodied in software stored on a tangible computer readable medium. Such computer readable medium as used herein refers to any non-transitory medium or combination of media that participates in providing instructions to a processor for execution. Such a medium comprises all computer readable media except for a transitory, propagating signal. For example, such computer readable medium may include a CD-ROM, a floppy disk, a hard drive, a digital versatile disk (DVD), a Blu-ray disk, or any other memory associated with the controller 16.

### INDUSTRIAL APPLICABILITY

The present disclosure relates generally to additive manufacturing techniques and, more particularly, relates to systems and methods for additive manufacturing that employ a roller and an iteratively constructed support structure for said roller. The systems and methods disclosed herein may be employed to reduce over-compression on 3-D printed objects that may be caused by a roller during manufacture. Such rollers can cause deflection on surfaces of the object, which can lead to object distortion and build failure. However, if the disclosed roller support structures are employed, in conjunction with the 3-D printing of an object, over-compression, deflection, and the associated risk of object distortion or part failure may be either reduced or eliminated.

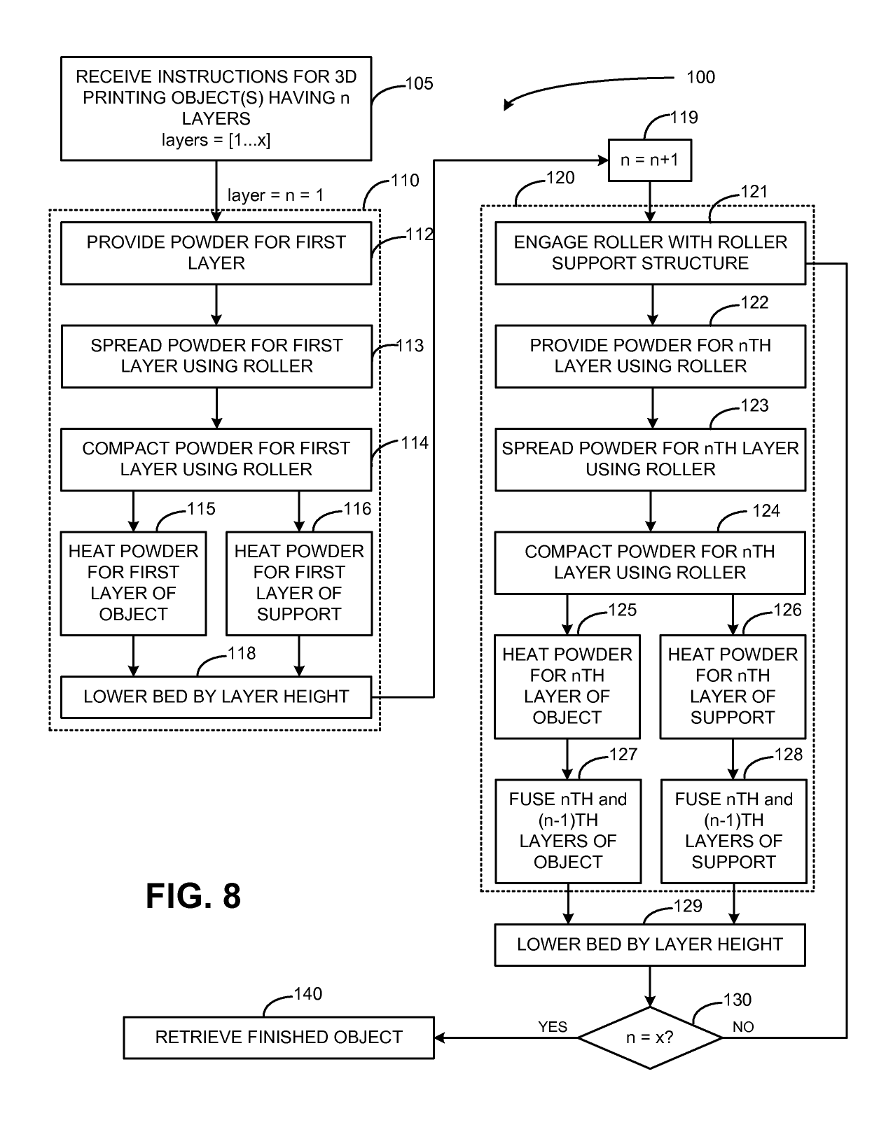

Turning now to FIG. 8, a flowchart for a method 100 for manufacturing one or more of the object(s) 12 is shown. The method 100 may be executed using the system 10 and, in some examples, by directing the 3-D printer 14 using instructions provided by the controller 16. The method 100 may begin at block 105 when the 3-D printer 14 receives instructions for 3-D printing the object(s) 12, as shown in block 105. Instructions for 3-D printing the object 12 may include “x” number of layers 22, wherein x is an integer representative of the number of layers 22 needed to complete manufacturing of the object 12. Therefore, as shown, the method 100 may be an iterative process having a series of layers to be printed (e.g., layers=[1 . . . x]), denoted by a set of consecutive integers. Accordingly, the current iteration for the current layer that the method 100 is printing can be denoted as the “nth” layer of the object 12. While the method 100 is described herein with reference to the structures and elements of the embodiments of FIGS. 1 and 2, the method 100 may additionally be used to produce the objects 54, 64, 74 and roller support structures 50, 60, 70 of FIGS. 3-5.

After receiving instructions, the method 100 may continue to a first process 110 for completing a first layer of the object 12. As such, the initial value of “n” may be 1. The first process 110 includes block 111, wherein the powdered material 20 is provided for the first layer of the object 12. Then, the roller 24 may spread the provided powdered material 20 to produce a powder layer (e.g., the powder layer 26) from which the first layer may be printed, as shown in block 113. Further, the roller may also compact the powder for the first layer, as shown in block 114. The laser 18 may then selectively heat the object portion 44 of the powder layer 26 to produce the first layer of the object 12, as shown in block 115. Additionally, the laser 18 may selectively heat the support portion 46 of the powder layer 26 to produce a first layer of the roller support structure 40, as shown in block 116.

To proceed to the next iteration of the method 100, the object bed 28 may then be lowered by a layer height, in advance of the printing of the next layer of the object 12 and the roller support structure 40, as shown in block 118. The method 100 may then include increasing n by 1 (see block 119: n=n+1) and continue to a nth process 120, which provides instructions for forming the nth layer of both the object 12 and the roller support structure 40.

The nth process 120 begins by engaging the roller 24 with the roller support structure 40 prior to spreading the powdered material 20 to create a powder layer 26, as shown in block 121. By engaging the roller 24 with the roller support structure 40, the downward forces inflicted upon the object 12 by the roller 24 may be significantly reduced and lead to a reduction in over compression and deflection upon the object 12. This, in turn, may lead to a decrease in the likelihood of build failure and/or shape distortion of the object 12.

The nth process 120 may then continue in a similar manner to the process 110, but for the nth layer of the object 12 and the corresponding roller support structure 40. As shown, the nth process 120 then will provide powder for the nth layer (block 122), spread the powdered material 20 for the nth layer using the roller 24 (block 123), compact the powder for the first layer (block 124). selectively heat the powder for the nth layer of the object 12 (block 125), and selectively heat the powder for the nth layer of the roller support structure 40 (block 126). As mentioned above, during 3-D printing processes, successive layers may be fused together during the heating of the current layer. As such, the process 110 may include fusing the nth layer of the object 12 to the (n−1)th layer of the object 12 (block 127) and fusing the nth layer of the roller support structure 40 to the (n−1)th layer of the roller support structure 50 (block 128). Once the heating of the powder is complete, the nth process 120 may lower the object bed 28 by the layer height, as shown in block 129.

The method 100 may proceed by determining if n, the current iteration, is equal to x, the integer representing the final iteration of the method 100, as shown in block 130. If n is not equal to x, then the method 100 returns to block 119, adds 1 to n, and repeats the nth process 120 for the nth layer. If n is equal to x, then the method 100 continues to block 140, wherein the object 12 may be retrieved from the 3-D printer 14. Because the method 100 uses the roller support structure 40 to reduce forces and compression on the object 12 caused by the roller 24, the likelihood of object shape distortion and build failure may be lessened when compared to prior art manufacturing methods.

It will be appreciated that the present disclosure provides systems, methods, and apparatus for manufacturing objects utilizing 3-D printing. While only certain embodiments have been set forth, alternatives and modifications will be apparent from the above description to those skilled in the art. These and other alternatives are considered equivalents and within the spirit and scope of this disclosure and the appended claims.

What is claimed is:

1. A system for manufacturing one or more objects, the system comprising:
a laser configured to selectively heat a powdered material to form the one or more objects in series of layer-wise iterations;
an object bed, on which the one or more objects rest during manufacturing, the object bed lowerable by a layer height in conjunction with each of the series of layer-wise iterations;
a roller configured to spread a powder layer of the powdered material on to the object bed prior to each of the series of layer-wise iterations; and
a roller support structure formed from the powdered material by the laser during the series of layer-wise iterations.

2. The system of claim 1, wherein the roller support structure includes at least two substantially parallel support members.

3. The system of claim 2, wherein the one or more objects are formed in between the at least two substantially parallel support members.

4. The system of claim 2, wherein the roller support structure further includes a crossing support member having a first end proximate to one of the at least two substantially parallel support members and a second end proximate to another of the at least two substantially parallel support members.

5. The system of claim 1, wherein the roller support structure includes at least two crossing members.

6. The system of claim 1, wherein the roller support structure defines an enclosure for the one or more objects.

7. The system of claim 1, further comprising one or more powder beds associated with the roller and configured to provide the powdered material to the roller prior to the roller spreading the powder layer of the powdered material on to the object bed prior to each of the series of layer-wise iterations.

8. A method for manufacturing one or more objects, the method comprising:
spreading, by a roller, a first powder layer of a powdered material on to an object bed;
heating, by a laser, first selective object portions of the first powder layer to form a first object layer of the one or more objects; and
heating, by the laser, first selective roller support portions of the first powder layer to form a first support layer of a roller support structure.

9. The method of claim 8, further comprising:
lowering the object bed by a layer height;
engaging the roller with the roller support structure;
spreading a second powder layer of the powdered material on to the object bed;
heating second selective object portions of the second powder layer to form a second object layer of the one or more objects; and
heating second selective roller support portions of the second powder layer to form a second support layer of the roller support structure.

10. The method of claim 9, further comprising:
fusing the second object layer to the first object layer; and
fusing the second support layer to the first support layer.

11. The method of claim 8, further comprising providing the powdered material to the roller for spreading on the object bed.

12. The method of claim 8, wherein heating the first selective roller support portions of the first powder layer to form a first support layer of a roller support structure includes heading a first member portion of the first powder layer and a second member portion of the first powder layer.

13. The method of claim 12, wherein the first and second member portions of the first powder layer are substantially parallel.

14. The method of claim 12, wherein the first and second member portions of the first powder layer form a crossing pattern on the object bed.

15. The method of claim 8, further comprising receiving three dimensional (3-D) printing instructions for manufacturing the one or more objects.

16. A three-dimensional (3-D) printer, comprising:
an object bed on which one or more objects are formed;
a powder bed for providing a powdered material to the object bed;
a roller for spreading the powdered material on the object bed as a powder layer;
a laser configured to selectively heat the powdered material; and
a controller in communication with, at least, the object bed, the roller, and the laser, the controller configured to execute instructions for:
spreading a powder layer of the powdered material on to the object bed using the roller prior to each of a series of layer-wise iterations of heating by the laser;
heating the powder layer, using the laser, at selective object portions of the powder layer to form the one or more objects during the series of layer-wise iterations; and
heating the powder layer, using the laser, at selective support portions of the powder layer to form a roller support structure during the series of layer-wise iterations.

17. The 3-D printer of claim 16, wherein the controller is further configured to provide instructions for lowering the powder bed by a layer height after each iteration of the series of layer-wise iterations.

18. The 3-D printer of claim 16, wherein the instructions executed by the controller are layer-wise, iterative 3-D printing instructions stored on a memory.

19. The 3-D printer of claim 16, wherein the powdered material is a metallic powder used to form metallic objects.

20. The 3-D printer of claim 16, wherein the laser is a selective sintering laser.
